(19) United States
(12) Patent Application Publication
(10) Pub. No.: US 2008/0025219 A1
(43) Pub. Date: Jan. 31, 2008

(54) METHOD FOR HANDLING THE BANDWIDTH ALLOCATION OF A NETWORKING DEVICE

(75) Inventors: Yun-Fei Chao, Taipei (TW); Wei-Pin Chen, Taipei (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: VIA TECHNOLOGIES, INC., Taipei (TW)

(21) Appl. No.: 11/460,343

(22) Filed: Jul. 27, 2006

(51) Int. Cl. H04L 12/26; H04J 1/16; H04L 12/56; H04J 3/22

(52) U.S. Cl. 370/235; 370/468; 370/389; 370/230

(57) ABSTRACT

The invention provides a method for handling the bandwidth allocation of a networking device. The networking device forwards a plurality of packets. A host attribute table is first searched according to a host attribute of the packets to obtain a host attribute table index of the packets. An application attribute table is then searched according to an application attribute of the packets to obtain an application attribute table index of the packets. A bandwidth profile table is then searched according to both the host attribute table index and the application attribute table index of the packets to obtain a bandwidth profile of the packets. Finally, the packets are limited to a specific bandwidth according to the bandwidth profile of the packets.

### BACKGROUND OF THE INVENTION

1. Field of the Invention

The invention relates to a networking device, and more particularly to bandwidth management of a networking device.

2. Description of the Related Art

Accessing the Internet has become a part of daily life. People access the Internet to shop, chat, write letters, pay taxes, and make friends. An increasing number of services are continually provided via the Internet. In the past, people talked to each other via telephone. Now people can talk to each other via a network connection. People can also watch television programs received via Internet connection.

People access the Internet through the provider network of an Internet Service Provider (ISP). As the number of Internet applications continues to increase, the provider network continues to receive more Internet access requests. The provider network, however, has only finite bandwidth. Thus, the packet flows connected to the provider network must share a finite bandwidth. To determine how much bandwidth a packet flow deserves, the networking devices of the provider network must classify the packet flows. This is called “packet classification”.

FIG. 1 shows a packet classification table 100. The networking devices of the provider network classify packets according to the packet classification table 100 to limit the bandwidth, which is utilized by the packets. The packets are classified into one of the packet conditions 106 according to the packet attributes 102. Each of the packet attributes 102 is certain content bits stored in a predetermined field of each of the packet headers. The packet attributes 102 of the packet classification table 100 are predetermined by the ISP of the provider network. Assume that there are N packet attributes, attribute A to attribute N, in the packet classification table 100. The content bit corresponding to each of the packet attributes 102 is classified to a few cases. For example, the packet attribute A is classified into case A₀˜A₁, and the packet attribute B is classified into case B₀˜B_{J}. All of the cases of the packet attributes are combined to obtain of the packet conditions 0 to X.

Each time when a networking device of the provider network receives a packet flow, the content bits of the packet header are compared with the cases of the packet attributes A˜N to find the matching packet condition. Because each packet condition has a corresponding bandwidth profile, the packet flow is granted the bandwidth profile according to the corresponding packet condition. The networking device then limits the flow rate of the packet flow according to the granted bandwidth profile. Thus, the networking devices of the provider network can determine the bandwidth allocation according to the packet classification table 100.

The packet classification table 100, however, occupies an excessive amount of memory capacity. For example, because there are N attributes, there are ((I+1)×(J+1)× . . . ×(K+1)) entries in the packet classification table 100. Not only the packet classification table 100 occupies a great amount of memory capacity, but also the networking devices must compare ((I+1)×(J+1)× . . . ×(K+1)) packet conditions to determine the bandwidth profile, causing latency in packet processing and lowering the total bandwidth of the networking device. Thus, a method for handling the bandwidth allocation of a networking device is desirable.

### BRIEF SUMMARY OF THE INVENTION

The invention provides a method for handling the bandwidth allocation of a networking device. The networking device forwards a plurality of packets. A host attribute table is first searched according to a host attribute of the packets to obtain a host attribute table index of the packets. An application attribute table is then searched according to an application attribute of the packets to obtain an application attribute table index of the packets. A bandwidth profile table is then searched according to both the host attribute table index and the application attribute table index of the packets to obtain a bandwidth profile of the packets. Finally, the packets are limited to a specific bandwidth according to the bandwidth profile of the packets.

The invention also provides a networking device, which forwards a plurality of packets. The networking device comprises a memory storing a host attribute table, an application attribute table, and a bandwidth profile table. The networking device also comprises a controller, which is coupled to the storage device, for searching a host attribute table according to a host attribute of the packets to obtain a host attribute table index of the packets, searching an application attribute table according to an application attribute of the packets to obtain an application attribute table index of the packets, searching a bandwidth profile table according to both the host attribute table index and the application attribute table index of the packets to obtain a bandwidth profile of the packets, and limiting the packets to a specific bandwidth according to the bandwidth profile of the packets.

The invention also provides a method for handling the bandwidth allocation of a networking device. The networking device forwards a plurality of packets. First, a plurality of attribute tables are respectively searched according to a plurality of attributes of the packets to obtain a plurality of attribute table indexes of the packets, wherein the attributes are contents of some fields of the packet header of the packets. A bandwidth profile table is then searched according to all of the attribute table indexes of the packets to obtain a bandwidth profile of the packets. The packets are then limited to a specific bandwidth according to the bandwidth profile of the packets.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional packet classification table;

FIG. 2 is a set of lookup tables for handling the bandwidth allocation of a networking device according to the invention;

FIG. 3 is a method for handling the bandwidth allocation of a networking device according to the invention;

FIG. 4 is a networking device handling the bandwidth allocation according to the invention;

FIG. 5 is a set of lookup tables for handling the bandwidth allocation of a networking device according to the invention; and

FIG. 6 is a method for handling the bandwidth allocation of a networking device according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

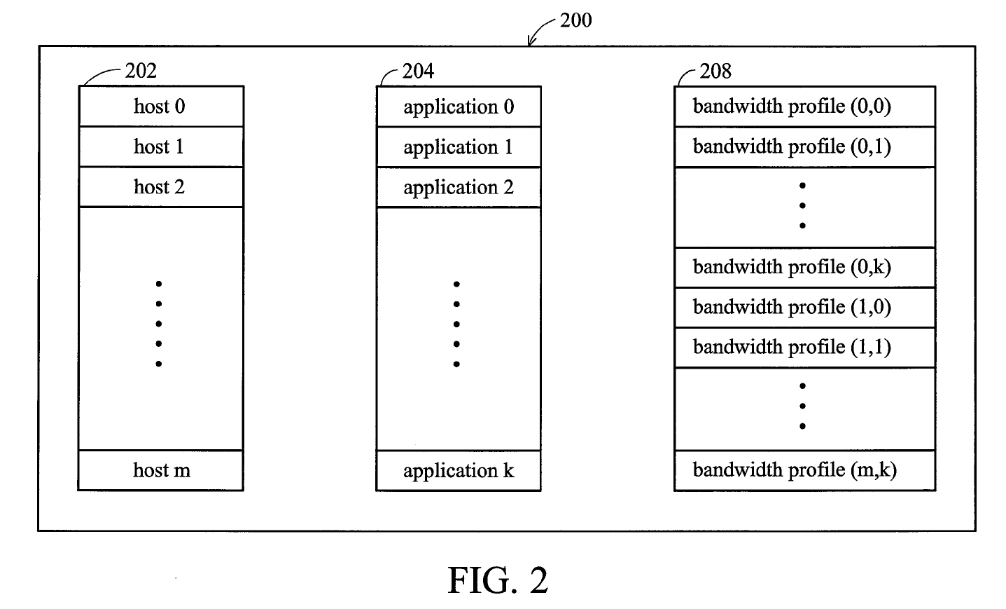

FIG. 2 is a set of lookup tables 200 for handling the bandwidth allocation of a networking device according to the invention. Because the ISP of the provider network hopes to determine the bandwidth allocation according to the application types of the packet flow, the set of lookup tables 200 includes an application attribute table 204. Because the ISP of the provider network also hopes to determine the bandwidth allocation according to the hosts of the packet flow, the set of lookup tables 200 includes a host attribute table 202. The set of lookup tables 200 also includes a bandwidth profile table 208, which stores different kinds of bandwidth profiles. Both the host attribute table 202 and the application attribute table 204 are 1-dimensional array, but the bandwidth profile table 208 is a 2-dimensional array.

The data of the host attribute table 202 are different cases of the host attribute. In one embodiment, the host attribute may be a Media Access Control (MAC) address of the hosts. Because the host attribute of packets is supposed to be classified into (m+1) categories, and the range of the index values of the host attribute table 202 is from 0 to m. The data of the application attribute table 204 is different cases of the application attribute. The application attribute is determined according to the application type of the packet flows, such as the Voice over Internet Protocol (VoIP) packet flows or the Internet Protocol Television (IPTV) packet flows. In one embodiment, the application attribute may be the three IP Precedence bits in the Type of Service (ToS) field of the IP header of the packets, or other fields of the transmission or application layer packet headers. Because the application attribute of packets is supposed to be classified into (k+1) categories, the range of the index values of the application attribute table 204 is from 0 to k.

Because the bandwidth profile table 208 is a 2-dimensional array, the index of the bandwidth profile table 208 includes a first index and a second index. The range of the first index values of the bandwidth profile table 208 is identical to the range of the index values of the host attribute table 202 (i.e. m+1), and the range of the second index values of the bandwidth profile table 208 is identical to the range of the index values of the application attribute table 204 (i.e. k+1). In other words, the index of the bandwidth profile table 208 is a combination of the indexes of the host attribute table 202 and the application attribute table 204, and ranges from (0, 0) to (m, k). The data of the bandwidth profile table 208 is the bandwidth profile classified according to corresponding host attribute types and application attribute types.

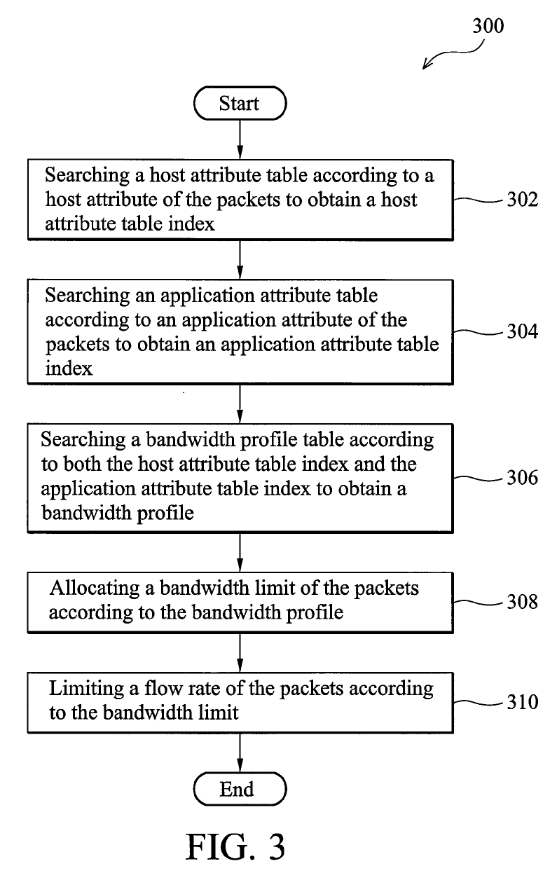

FIG. 3 is a method 300 for handling the bandwidth allocation of a networking device according to the invention. The networking device is a part of a provider network and forwards a plurality of packets. When the networking device receives the packets, searching the host attribute table 202 first according to a host attribute of the packets in step 302. As described above, the host attribute may be a MAC address of the hosts. When the packets are upstream packets, the networking device can compare the source MAC address field of the packets with the entries of the host attribute table 202. Otherwise, when the packets are downstream packets, the networking device can compare the destination MAC address field of the packets with the entries of the host attribute table 202. Because the host attribute of packets is classified into (m+1) categories, an entry corresponding to the host attribute of the packets can be found in the host attribute table 202, and the host attribute table index X of the corresponding entry is returned to the networking device by the host attribute table 202.

The application attribute table 204 is then searched according to an application attribute of the packets in step 304. As explained above, the application attribute is determined by the application type of the packet, and may be the content bits of a field of the packet headers. Thus, the networking device compares the content bits of the application attribute of the packets with the entries of the application attribute table 204. Because the application attribute of packets is classified into (k+1) categories, an entry corresponding to the application attribute of the packets can be found in the application attribute table 204, and the application attribute table index Y of the corresponding entry is returned to the networking device by the application attribute table 204.

Because the host attribute table index X has been obtained in step 302 and the application attribute table index Y has been obtained in step 304, the bandwidth profile table 208 is then searched according to both the host attribute table index and the application attribute table indexin step 306. Because the index of the bandwidth profile table 208 is a combination of the indexes of the host attribute table 202 and the application attribute table 204, an entry with the index (X, Y) can be found in the bandwidth profile table 208, and the bandwidth profile corresponding to the entry is returned to the networking device by the bandwidth profile table 208. Because the bandwidth profile contains information about bandwidth allocation, the networking device can limit the packets to a specific bandwidth according to the bandwidth profile in step 308. The networking device then limits the flow rate of the packets according to the specific bandwidth in step 310.

Thus, the networking device can handle the bandwidth allocation of received packets with the host attribute table 202, the application attribute table 204, and the bandwidth profile table 208. Because both the host attribute table 202 and the application attribute table 204 are 1-dimensional arrays, the memory space occupied by the three tables is much smaller. In addition, instead of comparing the packet header with ((m+1)×(k+1)) packet conditions of the packet classification table 100, the networking device only needs to compare m+1 kinds of host attributes and k+1 kinds of application attributes. Thus, the latency for determining the bandwidth allocation is decreased, and the total bandwidth of the networking device is increased.

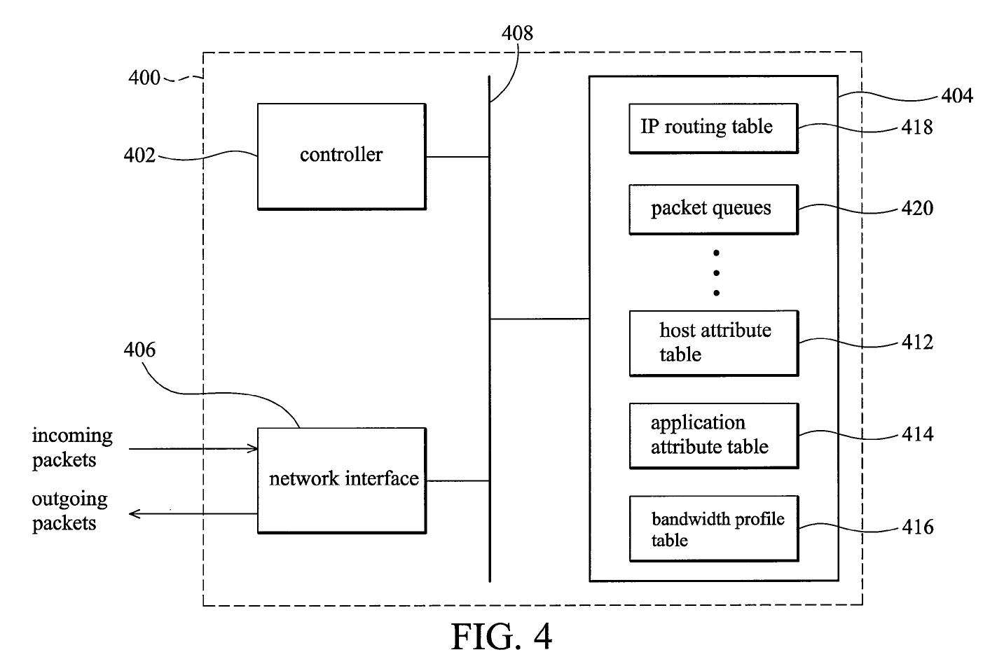

FIG. 4 is a networking device 400 handling the bandwidth allocation according to the invention. The networking device 400 is a part of a provider network. The networking device 400 forwards a plurality of packets and may be a network switch or router. The networking device 400 includes a controller 402, a memory 404, a network interface 406, and a bus 408. The bus 408 connects the controller 402, the network interface 406, and the memory 404. The network interface 406 receives the incoming packets and, forwards the outgoing packets under the control of the controller 402. When a few incoming packets are delivered to the networking device 400, the network interface 406 receives the incoming packets, which are then stored in the packet queues 420 of the memory 404. In addition to the packet queues 420, the memory 404 also stores a host attribute table 412, an application attribute table 414, and a bandwidth profile table 416. These three tables are respectively identical to the host attribute table 202, the application attribute table 204, and the bandwidth profile table 208.

When the networking device 400 needs to limit the incoming packets to a specific bandwidth, the networking device 400 implements method 300. The controller 402 first searches the host attribute table 412 according to a host attribute of the packets, and a host attribute tableindex of the packets is obtained. The controller 402 then searches the application attribute table 414 according to an application attribute of the packets, and an application attribute table index of the packets is obtained. The controller 402 then searches the bandwidth profile table 416 according to both the host attribute table index and the application attribute table index of the packets, and a bandwidth profile of the packets is obtained. Thus, the packets are limited to a specific bandwidth by the controller 402 according to the bandwidth profile of the packets, and a flow rate of the packets is limited according to the specific bandwidth under the control of the controller 406.

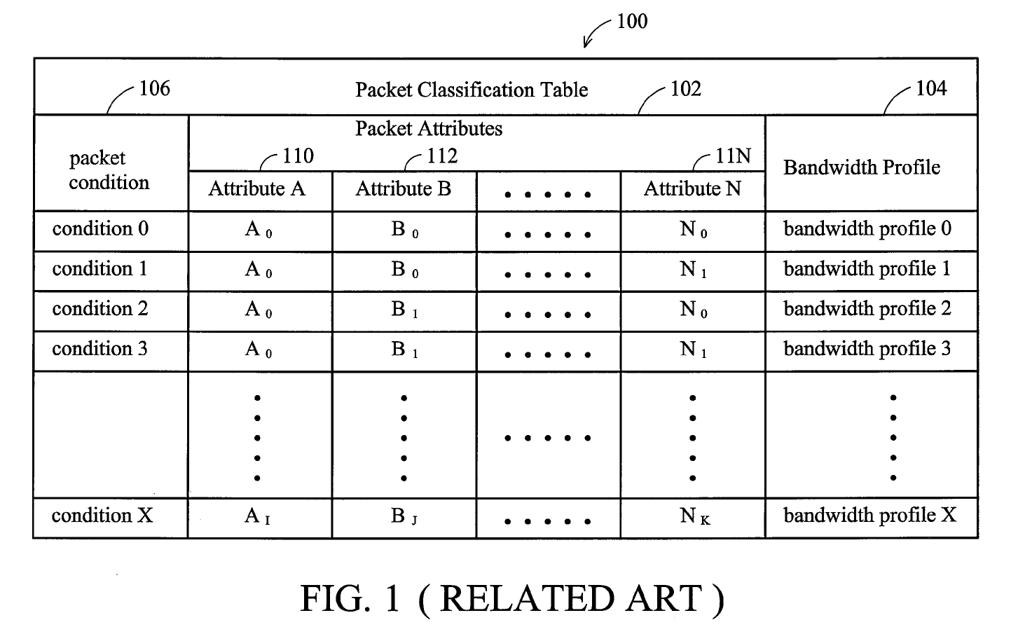

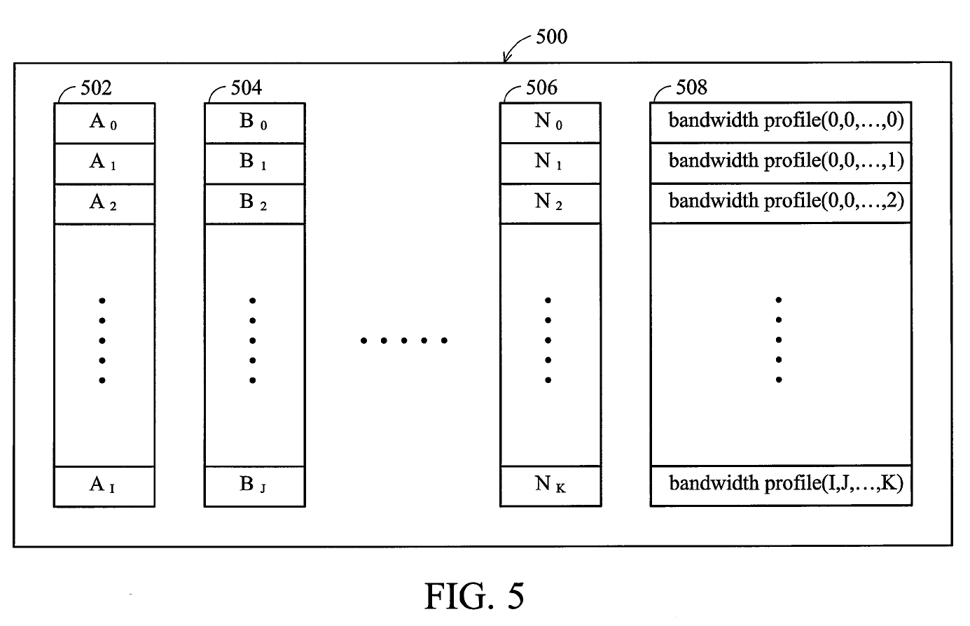

FIG. 5 is a set of lookup tables 500 for handling the bandwidth allocation of a networking device according to the invention. The set of lookup tables 500 can function as the packet classification table 100 of FIG. 1 to determine the specific bandwidth of the packets forwarded by a networking device, which is a part of a provider network. The set of lookup tables 500 includes a plurality of attribute tables 502˜506, and each of the attribute tables corresponds to one of the packet attributes 102 of the packet classification table 100. For example, the attribute table 502 corresponds to the attribute A of the packet classification table 100, the attribute table 504 corresponds to the attribute B of the packet classification table 100, and the attribute table 506 corresponds to the attribute N of the packet classification table 100. Each attribute table corresponds to certain content bits stored in some predetermined field of the packet headers and are predetermined by the ISP of the provider network. All the attribute tables are 1-dimensional arrays, and the data of the attribute tables are respectively different cases of the attributes.

The set of lookup tables 500 also includes a bandwidth profile table 508, according to how the networking device limits the packets to a specific bandwidth. If N is the number of the attributes 502˜506, the bandwidth profile table 508 is a N-dimensional array. The index of the bandwidth profile table 508 is a combination of the indexes of the attribute tables 502˜506, and the data of the bandwidth profile table 508 is the bandwidth profile. For example, if there are respectively I, J, . . . , and K kinds of cases in the attribute table 502, 504, . . . , and 506, the bandwidth profile table 508 includes (I×J× . . . ×K) entries.

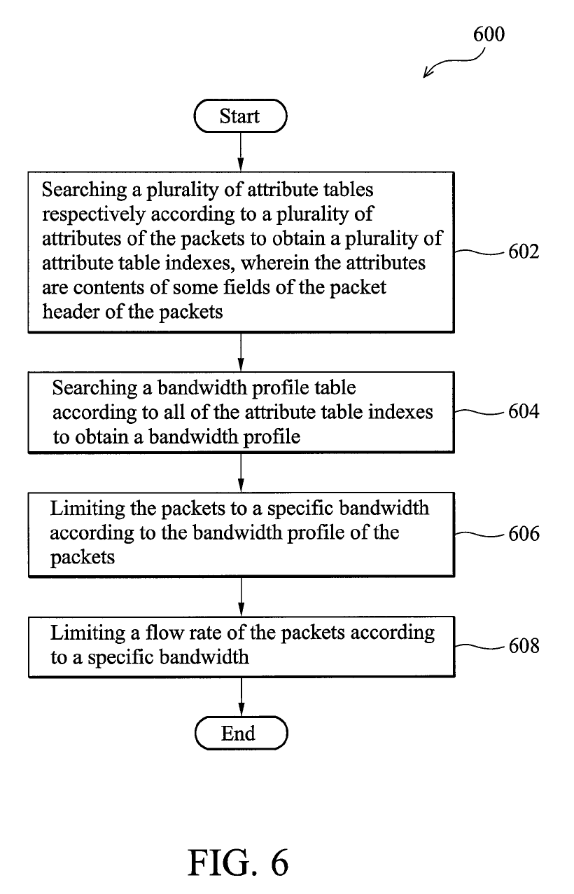

FIG. 6 is a method 600 for handling the bandwidth allocation of a networking device according to the invention. Each time when a networking device of the provider network receives a packet flow, the content bits of the packet header are compared with the cases of the attribute tables 502˜506 to respectively obtain a matched case index of one of the attribute tables 502˜506 in step 602. For example, when a packet is received, the networking device searches the attribute tables from 502 to 506 to respectively obtain attribute table indexes from i to k. The bandwidth profile table 508 is then searched according to the combination of the attribute table indexes (i, j, . . . , k) to obtain a bandwidth profile in step 604. Because the bandwidth profile contains information about bandwidth allocation, the networking device limits the packets to a specific bandwidth according to the bandwidth profile in step 606. The flow rate of the packets is then limited in step 608 according to the specific bandwidth.

The invention provides a method for handling the bandwidth allocation of a networking device. The conventional packet classification table is replaced with a host attribute table, an application attribute table and a bandwidth profile table, wherein the index of the bandwidth profile table is a combination of the host attribute table index and the application attribute table index. Thus, a bandwidth profile of packets can be determined according to the host attribute table, the application attribute table, and the bandwidth profile table. Because both the host attribute table and the application attribute table are 1-dimensional arrays, the three tables in comparison with the conventional packet classification table occupy less memory space. In addition, the latency for determining the bandwidth allocation of the packets is decreased.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for handling the bandwidth allocation of a networking device, wherein the networking device forwards a plurality of packets, the method comprising:
searching a host attribute table according to a host attribute of the packets to obtain a host attribute table index of the packets;
searching an application attribute table according to an application attribute of the packets to obtain an application attribute table index of the packets;
searching a bandwidth profile table according to both the host attribute table index and the application attribute table index of the packets to obtain a bandwidth profile of the packets; and
limiting the packets to a specific bandwidth according to the bandwidth profile of the packets.

2. The method as claimed in claim 1, wherein the method further comprises limiting a flow rate of the packets according to the specific bandwidth.

3. The method as claimed in claim 1, wherein the bandwidth profile table is a 2-dimensional array, the index of the bandwidth profile table is a combination of the host attribute table index and the application attribute table index, and the data of the bandwidth profile table is the bandwidth profile.

4. The method as claimed in claim 1, wherein both the host attribute table and the application attribute table are 1-dimensional arrays, and the data of the host attribute table and the application attribute table are respectively different cases of the host attribute and the application attribute.

5. The method as claimed in claim 1, wherein the host attribute is a source address of the packets when the packets are upstream packets, and the host attribute is a destination address of the packets when the packets are downstream packets.

6. The method as claimed in claim 1, wherein the application attribute is determined by the application type of the packets.

7. A networking device for forwarding a plurality of packets, comprising:
a memory for storing a host attribute table, an application attribute table, and a bandwidth profile table; and
a controller, which is coupled to the storage device, for searching the host attribute table according to a host attribute of the packets to obtain a host attribute table index of the packets, searching an application attribute table according to an application attribute of the packets to obtain an application attribute table index of the packets, searching a bandwidth profile table according to both the host attribute table index and the application attribute table index of the packets to obtain a bandwidth profile of the packets, and limiting the packets to a specific bandwidth according to the bandwidth profile of the packets.

8. The networking device as claimed in claim 7, wherein the networking device further comprises a network interface, which is coupled to the controller, for receiving the packets and forwarding the packets under the control of the controller.

9. The networking device as claimed in claim 7, wherein the controller limits a flow rate of the packets according to the specific bandwidth.

10. The networking device as claimed in claim 7, wherein the bandwidth profile table is a 2-dimensional array, the index of the bandwidth profile table is a combination of the host attribute table index and the application attribute table index, and the data of the bandwidth profile table is the bandwidth profile.

11. The networking device as claimed in claim 7, wherein both the host attribute table and the application attribute table are 1-dimensional array, and the data of the host attribute table and the application attribute table are respectively different cases of the host attribute and the application attribute.

12. The networking device as claimed in claim 7, wherein the host attribute is a source address of the packets when the packets are upstream packets, and the host attribute is a destination address of the packets when the packets are downstream packets.

13. The networking device as claimed in claim 7, wherein the networking device is a network switch or router.

14. A method for handling the bandwidth allocation of a networking device, wherein the networking device forwards a plurality of packets, the method comprising:
searching a plurality of attribute tables respectively according to a plurality of attributes of the packets to obtain a plurality of attribute table indexes of the packets, wherein the attributes are contents of some fields of the packet header of the packets;
searching a bandwidth profile table according to all of the attribute table indexes of the packets to obtain a bandwidth profile of the packets; and
limiting the packets to a specific bandwidth according to the bandwidth profile of the packets.

15. The method as claimed in claim 14, wherein the method further comprises limiting a flow rate of the packets according to the specific bandwidth.

16. The method as claimed in claim 14, wherein the bandwidth profile table is a N-dimensional array, N is the number of the attributes, the index of the bandwidth profile table is a combination of the attribute table indexes, and the data of the bandwidth profile table is the bandwidth profile.

17. The method as claimed in claim 14, wherein the attribute tables are 1-dimensional arrays, and the data of the attribute tables are respectively different cases of the attributes.

18. The method as claimed in claim 14, wherein the attributes includes a host attribute, which is a source address of the packets when the packets are upstream packets and a destination address of the packets when the packets are downstream packets.

19. The method as claimed in claim 18, wherein the host attribute is a Media Access Control (MAC) address of the packets.

20. The method as claimed in claim 14, wherein the attributes include an application attribute determined by the application type of the packets.
